(19) United States
(12) Patent Application Publication
(10) Pub. No.: US 2026/0261115 A1
(43) Pub. Date: Sep. 3, 2026

(54) PARALLEL ELECTRIC PATHS WITH ELECTRONIC DEVICES AND CURRENT LIMITING CIRCUITS

(71) Applicant: Infineon Technologies AG, Neubiberg (DE)

(72) Inventors: Walter Johann SLAMNIG, Latschach (AT); Norbert RIESER, Millstatt (AT); Stephan Wolfgang SCHWARZ, Spittal an der Drau (AT); Daniel SCHOBER, Großkirchheim (AT)

(73) Assignee: Infineon Technologies AG, Neubiberg (DE)

(21) Appl. No.: 19/541,504

(22) Filed: Feb. 17, 2026

(30) Foreign Application Priority Data
Feb. 28, 2025 (DE) 10 2025 107 814.9

(51) Int. Cl. H02H 9/02

(52) U.S. Cl. CPC H02H 9/025

(57) ABSTRACT

An electronic apparatus is disclosed. In one example, the electronic apparatus comprises a plurality of parallel electric paths, a plurality of electronic devices each arranged in a respective one of said plurality of parallel electric paths, and a plurality of current limiting circuits each arranged in an assigned one of said plurality of electric paths and in series with an assigned one of said plurality of electronic devices.

### CROSS-REFERENCE TO RELATED APPLICATION

This Utility Patent Application claims priority to German Patent Application No. 10 2025 107 814.9 filed February 28, 2025, which is incorporated herein by reference.

### BACKGROUND

### Technical Field

Various embodiments relate generally to an electronic apparatus, and a method.

### Description of the related art

After completing manufacture of semiconductor chips or packages of such semiconductor chips, such products are usually tested concerning their function. For this purpose, a test system composed of a prober and an electric test unit may be provided in which such products are tested as devices under test (DUT). However, DUTs may be prone to failure during testing the DUT. This may deteriorate reliability of the test and/or may damage the DUT.

Similar safety and reliability issues may arise in other electronic apparatuses.

### SUMMARY

There may be a need for safely and reliably operating electronic devices.

According to an exemplary embodiment, an electronic apparatus is provided which comprises a plurality of parallel electric paths, a plurality of electronic devices each arranged in a respective one of said plurality of parallel electric paths, and a plurality of current limiting circuits each arranged in an assigned one of said plurality of electric paths and in series with an assigned one of said plurality of electronic devices.

According to another exemplary embodiment, a method is provided which comprises arranging each of a plurality of electronic devices in a respective one of a plurality of parallel electric paths, arranging each of a plurality of current limiting circuits in an assigned one of said plurality of electric paths and in series with an assigned one of said plurality of electronic devices, and electrically operating each of said plurality of electric paths.

According to an exemplary embodiment, an electronic apparatus (such as a test apparatus with devices under test as electronic devices, or other electronic circuitry with one or more electronic devices, such as operational amplifiers, to be protected) is equipped with multiple parallel electric paths, such as two or more electronic paths connected electrically in parallel to each other. Moreover, a plurality of electronic devices may be provided, wherein, for each electric path, at least one of said electronic devices can be connected within an assigned one of said parallel electric paths. Beyond this, a plurality of current limiting circuits may be foreseen, at least one per electric path. Advantageously, each of the current limiting circuits may be connected within a dedicated one of said electric paths and may be connected in series with an assigned one of said electronic devices which is arranged in the same electric path as the corresponding current limiting circuit. When, during operation of the electronic apparatus, the electric current flowing through a respective electric path becomes excessively or undesirably high, the current limiting circuit may limit the electric current flowing in said electric path so as to protect the one or more electronic devices in said electric path. By such a path-specific current limiting circuitry in an electronic apparatus having multiple such parallel electric paths, it may be on the one hand possible to protect the electronic devices (for instance sensitive semiconductor dies), which may be prone to failure in the event of overcurrent and/or high-voltage peaks. On the other hand, the provision of a current limiting circuit per parallel electric path may also protect other constituents of the electronic apparatus (for instance a high-voltage source supplying one or more of said electric paths with electric voltage or electric current), for instance against short-circuiting in the event of a failure. Thus, the provided electronic circuitry of the electronic apparatus may allow to safely and reliably operate the electronic devices, and may also provide protection to one or more constituents of the electronic apparatus.

### BRIEF DESCRIPTION OF THE DRAWINGS

The accompanying drawings, which are included to provide a further understanding of exemplary embodiments and constitute a part of the specification, illustrate exemplary embodiments.

In the drawings:

FIG. 1 shows a schematic view of an electronic apparatus according to an exemplary embodiment.

FIG. 2 shows the electronic apparatus according to FIG. 1 during operation.

FIG. 3 shows a schematic view of a current limiting circuit of an electronic apparatus according to an exemplary embodiment.

FIG. 4 shows a schematic view of a current limiting circuit of an electronic apparatus according to another exemplary embodiment.

FIG. 5 shows a schematic view of part of an electronic apparatus according to another exemplary embodiment.

FIG. 6 shows a schematic view of an electronic apparatus according to another exemplary embodiment.

### DETAILED DESCRIPTION

There may be a need for safely and reliably operating electronic devices.

According to an exemplary embodiment, an electronic apparatus is provided which comprises a plurality of parallel electric paths, a plurality of electronic devices each arranged in a respective one of said plurality of parallel electric paths, and a plurality of current limiting circuits each arranged in an assigned one of said plurality of electric paths and in series with an assigned one of said plurality of electronic devices.

According to another exemplary embodiment, a method is provided which comprises arranging each of a plurality of electronic devices in a respective one of a plurality of parallel electric paths, arranging each of a plurality of current limiting circuits in an assigned one of said plurality of electric paths and in series with an assigned one of said plurality of electronic devices, and electrically operating each of said plurality of electric paths.

According to an exemplary embodiment, an electronic apparatus (such as a test apparatus with devices under test as electronic devices, or other electronic circuitry with one or more electronic devices, such as operational amplifiers, to be protected) is equipped with multiple parallel electric paths, such as two or more electronic paths connected electrically in parallel to each other. Moreover, a plurality of electronic devices may be provided, wherein, for each electric path, at least one of said electronic devices can be connected within an assigned one of said parallel electric paths. Beyond this, a plurality of current limiting circuits may be foreseen, at least one per electric path. Advantageously, each of the current limiting circuits may be connected within a dedicated one of said electric paths and may be connected in series with an assigned one of said electronic devices which is arranged in the same electric path as the corresponding current limiting circuit. When, during operation of the electronic apparatus, the electric current flowing through a respective electric path becomes excessively or undesirably high, the current limiting circuit may limit the electric current flowing in said electric path so as to protect the one or more electronic devices in said electric path. By such a path-specific current limiting circuitry in an electronic apparatus having multiple such parallel electric paths, it may be on the one hand possible to protect the electronic devices (for instance sensitive semiconductor dies), which may be prone to failure in the event of overcurrent and/or high-voltage peaks. On the other hand, the provision of a current limiting circuit per parallel electric path may also protect other constituents of the electronic apparatus (for instance a high-voltage source supplying one or more of said electric paths with electric voltage or electric current), for instance against short-circuiting in the event of a failure. Thus, the provided electronic circuitry of the electronic apparatus may allow to safely and reliably operate the electronic devices, and may also provide protection to one or more constituents of the electronic apparatus.

### DESCRIPTION OF FURTHER EXEMPLARY EMBODIMENTS

In the following, further exemplary embodiments of the electronic apparatus, and the method will be explained.

In the context of the present application, the term “electronic device” may particularly denote any electronic component, electronic member, electronic system or electronic circuitry. Such an electronic device may for instance be a semiconductor chip (in particular a power semiconductor chip), an active electronic device (such as a transistor), a passive electronic device (such as a capacitance or an inductance or an ohmic resistance), a sensor (such as a microphone, a light sensor or a gas sensor), an actuator (for instance a loudspeaker), and/or a microelectromechanical system (MEMS). However, in other embodiments, the electronic device may also be of different type, such as a mechatronic member, in particular a mechanical switch, etc. In particular, the electronic device may be a semiconductor chip having at least one integrated circuit element (such as a diode or a transistor) in a surface portion thereof. The electronic device may be a bare die or may be already packaged or encapsulated. Semiconductor chips implemented according to exemplary embodiments may be formed in silicon technology, gallium nitride technology, silicon carbide technology, etc. however, also other electronic members may form a respective electronic device, such as a driver circuitry, an analog-to-digital converter or a digital-to-analog converter, an input stage, an operational amplifier or another type of amplifier, and/or a logic circuitry. The electronic device may be hard-wired and/or implemented at least partially in software. Also passive components may be further examples of an electronic device, for example a resistor, a capacitor or an inductor. The electronic device may also be an electronic system, such as one or more surface mounted components (such as semiconductor dies) on a mounting board (for example a printed circuit board). The electronic device may be a discrete device, such as a separated semiconductor die. Alternatively, the electronic device may be interconnected with at least one other element, for instance with one or a plurality of further electronic devices. For instance, a plurality of electronic devices connected in the electronic apparatus may be integrally connected on wafer level while being operated in the electronic apparatus, for instance before separating the electronic devices to individual bodies.

In the context of the present application, the term “parallel electric paths” may particularly denote at least two, at least three, at least four, or at least five, more specifically at least ten, electric paths which are connected in parallel to each other. The parallel electric paths may comprise a mutual electric connection point at which electricity is split into the parallel electric paths or is combined from the parallel electric paths. Thus, some or all of the parallel electric paths may be interconnected. It may however also possible that the parallel electric paths are completely parallel to each other and independently from each other. Each electric path may comprise an electrically conductive connection medium, such as a metallic wire or cable. At least one electronic device and at least one current limiting circuit may be connected in such an electric path, for instance permanently or temporarily (for instance substitutably). For example in the application of a chip test, the electronic devices may be assembled temporarily in the various electric paths and may be taken out of the electric paths after completing testing.

In the context of the present application, the term “current limiting circuit” may particularly denote electric circuitry and/or electronic members providing the functionality of limiting electric current flowing through an electric path in which the respective current limiting circuit is interconnected. For example, a current limiting circuit may be embodied for limiting current flow when the current in the assigned electric path exceeds a threshold value defined by the current limiting circuit. For instance, the current limiting circuit may block any current flow through the electric path when and as long the current exceeds the threshold value. Alternatively, the current limiting circuit may limit the current flow to a non-zero acceptable value in the assigned electric path. In an embodiment, the current limiting circuit may be operative for limiting or blocking current flow through the assigned electric path without being destroyed itself in the event of overcurrent, as it may be the case in a fuse. In an embodiment, the current limiting circuit may be embodied to disable current flow as long as the electric current exceeds an acceptable value, and to re-enable current flow when the previously excessive electric current has returned to an acceptable value or below a threshold value. Advantageously, the current limiting circuit may be configured to operate for current limitation in a self-acting manner without active and/or external control. For example, the current limiting functionality of the current limiting circuit may be activated automatically when the current flowing through the current limiting circuit exceeds a predetermined threshold value. Alternatively, a current limiting circuit may be controlled by an external control device. For instance, the external control device may control the current limiting circuit to limit the current in the assigned electric path when a sensor has sensed the presence of an excessive current in the electric path and has transmitted corresponding sensor information to the control device.

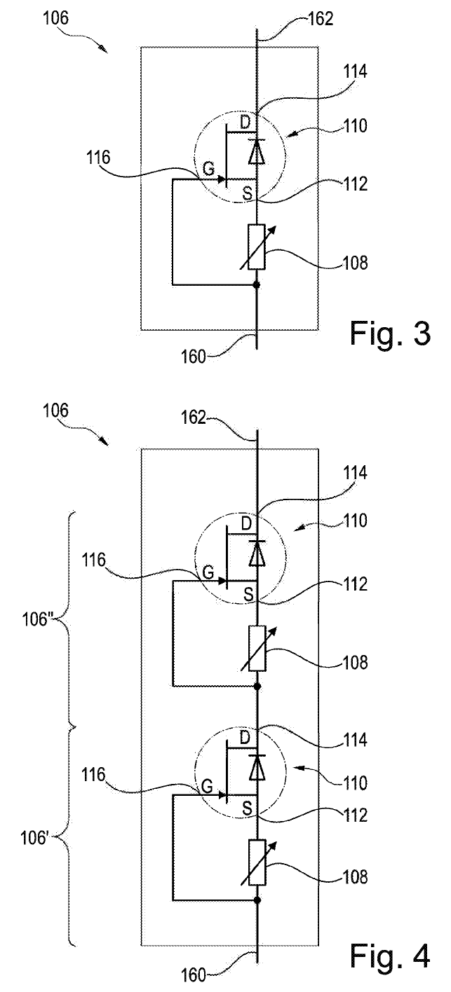

In an embodiment, at least one of said current limiting circuits comprises or consists of an adjustable resistance in series with a transistor or arranged between two transistors. Such a design (see for instance FIGS. 3 to 5) is simple in construction and may nevertheless allow to obtain a reliable current limiting functionality without the need of active control.

In an embodiment, at least one of said current limiting circuits comprises a transistor having two connection terminals (in particular a source terminal and a drain terminal) and a control terminal (in particular a gate terminal) connected with one of said connection terminals. When the transistor is a field-effect transistor, source, drain and gate terminals may be provided. When the transistor is however a bipolar transistor, the mentioned terminals may be base, emitter and collector terminals.

In an embodiment, at least one of said current limiting circuits comprises a field-effect transistor having a source terminal, a drain terminal and a gate terminal connected with the source terminal. A gate-source coupling may define an operating point of the transistor. The transistor may be connected and configured so that, when excessive current is present, current flow between source terminal and drain terminal may be limited automatically. When there is no longer an excessive current supplied, current flow between source terminal and drain terminal may be enabled automatically by the intrinsic transistor function only.

In an embodiment, at least one of said current limiting circuits comprises a depletion-type transistor. All types of transistors are possible, but with a depletion type transistor, no additional voltage supply is needed. A depletion-type transistor may be in a normally-“on”-state, so that the depletion-type transistor may be switched “off” only in the presence of an overcurrent. Consequently, current flow through the depletion-type transistor may be limited and the electronic device in the assigned electric path may be protected against said overcurrent, in particular accompanied by a high voltage.

In an embodiment, at least one of said current limiting circuits comprises at least two current limiting stages, in particular at least two current limiting stages with corresponding circuitry, connected in series. Descriptively speaking, a current limiting circuit comprising a plurality of serial current limiting stages (as in FIG. 4, for example) may allow to operate the electronic apparatus at higher voltage, since each current limiting stage may be configured for bearing a respective portion of the entire voltage applied to the electronic devices in the parallel electric paths.

In an embodiment, the electronic apparatus comprises a common first electric potential provision unit connected to each of said parallel electric paths and configured for maintaining a predefined first electric potential, in particular a high voltage potential, provided to each of said parallel electric paths. The common first electric potential provision unit may be connected to each of the parallel electric paths, for instance at a splitting or combining node. The common first electric potential provision unit may provide and ensure maintenance of a well-defined first electric potential. For instance, said first electric potential may be an upper electric potential of the connected electronic devices, for instance a high voltage potential (in particular at least 1000 V).

In an embodiment, the electronic apparatus comprises a plurality of second electric potential provision units each connected in a respective one of said parallel electric paths and configured for maintaining a predefined second electric potential in the assigned electric path, in particular a ground potential. The individual second electric potential provision units provided separately for each electric path may be connected to one selected of the parallel electric paths, for instance not to the other electric paths. The respective individual second electric potential provision unit may provide and ensure maintenance of a path-specific and well-defined second electric potential. For instance, said second electric potential may be a lower electric potential of the connected electronic device, for instance a ground potential.

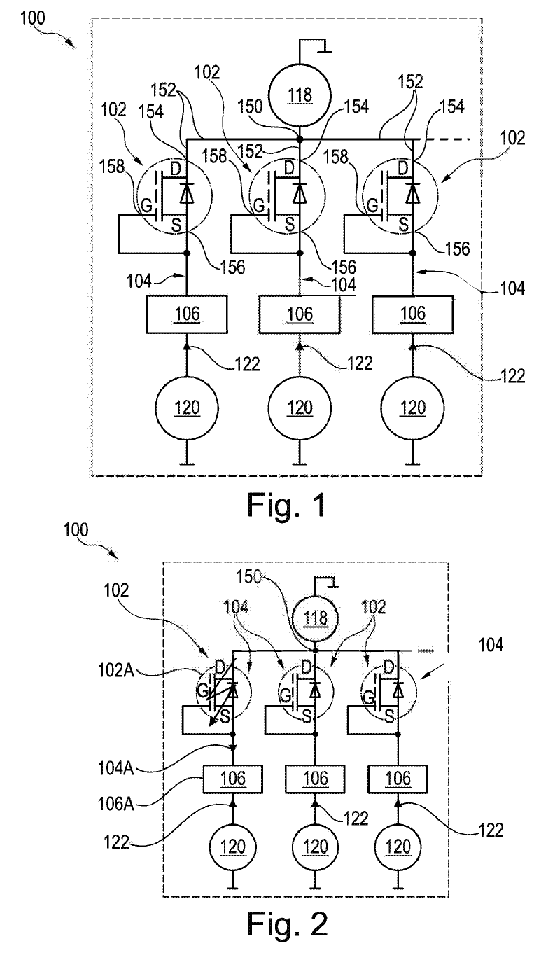

In a preferred embodiment, the first electric potential provision unit can provide an upper electric potential and the second electric potential provision units can provide a lower electric potential (see for instance FIG. 1). However, there is also the option of a common electric potential at a lower level compared with the electrical potential on each other end of the electric paths (see for instance FIG. 6).

In an embodiment, each electric path has a current measuring mechanism for measuring a current at the assigned electronic device when the first electric potential provision unit maintains its predefined first electric potential and when the assigned one of the second electric potential provision units maintains its predefined second electric potential. For instance, the current measuring mechanism in a respective electric path may be an amperemeter. For example, the measured current may be a leakage current of an electronic device as device under test in a respective electric path and in response to the application of a voltage between the first and second electric potential provision units.

In an embodiment, an electric voltage between the first electric potential and the second electric potential is at least 300 V, in particular at least 1 kV, preferably at least 2 kV or at least 3 kV. More generally, said electric voltage may be in particular in a range from a few volts or several tenth volts (for example from 50 V) up to a few thousand volts or more (for instance up to 10 kV).

In an embodiment, the common first electric potential provision unit is connected to drain terminals of each of the electronic devices. The respective second electric potential provision units may be connected to source terminals and/or gate terminals of the electronic devices, for instance through a respective current limiting circuit.

In an embodiment, each current limiting circuit is configured for limiting a current flow when or as long as an electric current flowing through the respective current limiting circuit exceeds a current limit value. In one option, the current limiting circuit may continue to allow a current flow only up to an acceptable value as long as a supplied current exceeds a predefined threshold value. When the actual current falls again below a predefined threshold value defining the lower limit of an overcurrent, the respective current limiting circuit may automatically re-allow current flow through the assigned electric path.

In an embodiment, each electric path comprises or consists of an identical circuitry. An identical circuitry may be obtained by using the same electronic members in the same arrangement in each electric path. Alternatively, it may also be possible that the circuitry of different electric paths is similar (for instance providing still the same functionality) or corresponding (for instance implementing corresponding, but not identical electronic members).

In an embodiment, the electronic devices are semiconductor packages, semiconductor chips, semiconductor power devices, transistor components, diodes, logic devices, operational amplifiers, input stages, analog-to-digital converters and/or devices under test. Any other electronic members are possible as electric devices as well. In the context of the present application, the term “device under test” (DUT) may particularly denote an electronic component such as a semiconductor wafer or a semiconductor chip which shall be tested concerning its desired functionality after manufacture. In particular, the device under test may be an electronic member configured as a power semiconductor wafer or chip, in particular for automotive applications.

In an embodiment, the electronic apparatus is configured as a test arrangement for testing said electronic devices, in particular simultaneously or in parallel. Correspondingly, the method may comprise electrically operating each of said plurality of electric paths, in particular simultaneously, for carrying out an electric test of said electronic devices while protecting said electronic devices against overcurrent by said plurality of current limiting circuits. In particular, a current limiter in a respective electric path may guarantee the test condition in a fail case of one chip. A protection for a low side source against high current and high voltage may be provided. Testing said electronic devices may involve applying a constant predefined electric potential or a predefined electric potential varying over time to the electronic devices and detecting their response. For instance, a current flow, such as a leakage current flow, through the electronic devices may be measured. The test arrangement may test different electronic devices at least partially simultaneously and/or at least partially sequentially. The test of the electronic devices may be carried out on wafer level or after separation of the wafer into individual electronic devices.

In an embodiment, the test arrangement is configured for measuring at least one electrical property, in particular an electric current, more particularly an electric leakage current, of an assigned one of said plurality of electronic devices in each of said electric paths. As an alternative to such static current measurements, it also be possible to carry out dynamic electric measurements, for instance applying pulses to the electronic devices and measuring their response.

In an embodiment, the electronic apparatus comprises at least one of a driver circuitry, an analog-to-digital converter, an input stage, an operational amplifier, and/or a logic circuitry encompassing at least one of said electronic devices and/or forming at least one further electronic device in at least one of said electric paths. Correspondingly, the method may comprise electrically operating each of said plurality of electric paths for forming at least one of a driver circuitry, an analog-to-digital converter, an input stage, an operational amplifier, and/or a logic circuitry forming at least one further electronic device and/or encompassing said electronic devices and being protected against overcurrent and high voltage by said plurality of current limiting circuits. Thus, the aforementioned electronic devices may be embodied as one or more of the mentioned and/or other electronic members. However, it may also be possible that at least one further electronic device is provided in a respective electric path in addition to the aforementioned electronic device.

In an embodiment, any of the electronic devices may be embodied as a transistor chip having a source pad, a drain pad and a gate pad. In particular, the source pad and the gate pad may be formed on the same main surface of the electronic chip. The drain pad may be formed on an opposing other main surface of the electronic chip. Such a transistor chip may be a chip fulfilling the function of a transistor, in particular of a field effect transistor. Such a transistor chip may be used for instance for semiconductor power applications. Such an electronic device may experience a vertical current flow during operation. However, lateral electronic devices may be implemented as well.

In an embodiment, the at least one electronic device comprises at least one of the group consisting of a controller circuit, a driver circuit, and a power semiconductor circuit. All these circuits may be integrated into one semiconductor chip, or separately in different chips. For instance, a corresponding power semiconductor application may be realized by the chip(s), wherein integrated circuit elements of such a power semiconductor chip may comprise at least one transistor (in particular a MOSFET, metal oxide semiconductor field effect transistor), at least one diode, etc. In particular, circuits fulfilling a half-bridge function, a full-bridge function, etc., may be manufactured.

As substrate or wafer for the semiconductor chips, a semiconductor substrate, preferably a silicon substrate, may be used. Alternatively, a silicon oxide or another insulator substrate may be provided. It is also possible to implement a germanium substrate or a III-V-semiconductor material. For instance, exemplary embodiments may be implemented in GaN or SiC technology.

The above and other objects, features and advantages will become apparent from the following description and the appended claims, taken in conjunction with the accompanying drawings, in which like parts or elements are denoted by like reference numbers.

The illustration in the drawing is schematically and not to scale.

Before exemplary embodiments will be described in more detail referring to the figures, some general considerations will be summarized based on which exemplary embodiments have been developed.

For an electrical test on semiconductors, it may be desired to keep a test condition at a target value. Especially for high voltage leakage current measurements, various problems and challenges arise. Such problems and challenges may involve the risk that a tested semiconductor device is destroyed and/or test equipment is deteriorated or damaged.

Various possibilities may be conventionally used to reduce these problems. In one conventional approach, a high voltage leakage current measurement may be carried out in serial using only one high voltage source. Since the measurements are carried out serially, it takes a very long time and is therefore cumbersome. Although there may be no major challenges for the test hardware, since the leakage current measurement can be done on the low side, there may be the additional risk that the source on the low side will be destroyed by the high-voltage source. Thus, very slow measurements as well as a possible destruction of the low side source are disadvantages of such a conventional approach.

In another conventional approach, a high voltage leakage current measurement may be executed in parallel using only one high voltage source. Although this measurement method may enable a reduction of test time compared to a serial method, in case of a defect device, it may not be possible to guarantee a well-defined test condition.

One possibility to solve this problem is to perform a serial re-measurement. However, such a re-measurement may take a lot of time and may involve high effort. The higher the parallelism, the higher the probability of a serial re-measurement. In addition, there may be a risk that the source on the low side will be destroyed by the high-voltage source. Thus, disadvantages of such a conventional approach are a very slow re-measurement in case of defect devices, and that a re-test rate may depend on yield and parallelism. Furthermore, a destruction of the low side source may occur.

In yet another conventional approach, high voltage leakage current measurements may be executed in parallel with one high-voltage source per site. With this variant, the leakage current has to be measured on the high voltage side. This increases the measurement time significantly, as it takes much longer to achieve a stable measurement. Additionally, it becomes much more difficult and expensive to build a functioning application hardware, because each site measured in parallel requires a high-voltage source. Thus, the mentioned approach has the disadvantages that leakage measurements on the high voltage side take a long time. In addition, hardware becomes more complex, because many sources are needed. Therefore, a high effort concerning the hardware and the testing may arise.

According to an exemplary embodiment, an electronic apparatus with integrated overcurrent protection may be provided. For example, such an electronic apparatus may be embodied as a test apparatus with plural devices under test (DUTs) as electronic devices, and/or other electronic circuitry with electronic devices to be protected, for instance an analog to digital converter (ADC). The mentioned electronic apparatus may be provided with a plurality of electric paths which may be connected and operated electrically in parallel. In addition, at least one electronic device may be foreseen per electric path. Moreover, each of the parallel electric paths may comprise at least one current limiting circuit. This may lead to a circuitry of the electronic apparatus according to which each electric path may comprise a serial connection of at least one current limiting circuit and at least one electronic device. In the event of an overcurrent flow in a respective one of the electric paths, the electric current in this electric path may be limited (for instance to zero or to an acceptably small value) by the current limiting circuit. Beneficially, this may protect at least one electronic device in the assigned electric path. In addition, also a positive impact on the other electric paths may be achieved, for instance preventing an overcurrent in those other electric paths as well by the entire set of current limiting circuits. This has advantages: Firstly, such a circuitry may ensure that electronic devices may be reliably protected against overcurrent and/or high-voltage peaks. Secondly, it may also be possible that the parallel connected arrangement of current limiting circuit protects one or more voltage sources applying electricity to the electric paths against short-circuiting. As a result, an electronic apparatus according to an exemplary embodiment may ensure safe and reliable operation of electronic devices and optionally other electronic members.

Advantageously, exemplary embodiments may allow to realize a plurality of very different applications. More specifically, the area of application with regard to the protection of electronic devices (such as electronic components) may include all kinds of metrological applications. In particular, said protection of electronic devices may include a protection against overcurrent and high-voltage peaks. However, exemplary embodiments may also be used in the field of testing devices under test (as the electronic devices), or protecting any kind of other electronic devices (such as amplifiers, converters, power devices and logic devices). Also, a self-protection of an electronic apparatus according to an exemplary embodiment may be achieved, for instance the protection of a high-voltage source against short circuitry.

To put it shortly, an exemplary embodiment provides an electronic apparatus having a high voltage current limit module and a high voltage protection circuit. An exemplary embodiment enables to provide a fast high voltage current limiting circuit without noteworthy additional hardware effort. A serial re-test on fail devices or additional high voltage sources may be advantageously dispensable. For example, a high voltage current limiter module can limit the maximum current per site to a certain value. In particular, exemplary embodiments may enable to perform a high voltage leakage current measurement with only one high voltage source. Advantageously, a serial re-test is not needed. Additionally, the probability of destruction of a voltage source (in particular of a low side source) may be significantly reduced.

For an embodiment in which the electronic apparatus is configured as a test apparatus for testing devices under test (DUT) as the electronic devices, the electric current may increase if a DUT is defective. This current may flow through a high voltage leakage current measurement circuitry and may cause a voltage drop across a potentiometer. For instance, a current limiting circuit of an electronic apparatus according to an exemplary embodiment may comprise a specifically connected transistor. In the event of an overcurrent, a gate of such a transistor (such as a JFET gate) may become more negative than its source, and the JFET may begin to pinch off itself. Thus, when a current flowing through the current limiting circuit becomes excessive, the transistor-type current limiting circuit may disable flow of excessive electric current through the transistor and through the connected electronic device of the same electric path. This may allow to achieve a current limitation, in particular a high voltage current limitation.

In an embodiment, a JFET-type current limiting circuit may be used advantageously in voltage classes up to for example 1800 V. Advantageously, it may be possible to cascade JFETs to increase the usable voltage range. With such a modified circuit, a maximum clamp voltage can be increased, for instance can be increased up to 3000 V and more. If two current limiter circuits are connected in series, one of two JFETs may work as described above. In the second current limiter circuit, an additional JFET may be configured to go into a voltage breakdown when a maximum permissible current is reached. This means that one JFET takes over the voltage until breakdown voltage and the second JFET takes over the remaining voltage and the actual current limitation. Thus, multiple-stages current limiting circuits may allow to provide a reliable current limiting functionality even at very high voltages.

Advantageously, a voltage drop across an additional resistance (such as one or more potentiometers) may be negligible for small currents (for instance for currents below 10 µA) in high voltage measurements. In an embodiment, the expected voltage drop can be maintained at the forced voltage for higher current values.

Beneficially, exemplary embodiments may enable faster and more efficient measurements for high voltage applications. Exemplary embodiments can be applied, for instance, to many different technologies such as SiCMOS, GaN, IGBTs, diodes, CoolMOS, etc.

According to an exemplary embodiment, a method to perform high voltage leakage current measurements using one or more high voltage current limiting modules or circuits may be provided. In particular, one or more high voltage current limiter modules may be used during high voltage leakage current measurement, wherein the high voltage current limiter module (such as a plurality of current limiting circuits) limits the maximum current per site to a certain value. For example, a transistor (such as a JFET) may be used to create a respective current limiting circuit. For instance in a scenario in which an electronic device (such as a DUT) is defective, the increased current causes the transistor (for example JFET) to pinch off or to reduce the current flow through itself, which may lead to a high-voltage current limitation. Preferably, a cascade arrangement of current limiting transistors (such as JFETS) can be used to handle higher voltages (such as 3000 V or more). Exemplary embodiments may offer benefits such as fast measurement using a single high voltage source, eliminating the need for serial re-tests, reducing the risk of low-side destruction, and/or lowering hardware effort.

Exemplary embodiments may implement the electronic apparatus as a test apparatus for testing devices under test (such as individual semiconductor dies or semiconductor dies on wafer level) as the electronic devices in the parallel electric paths serial with current limiting circuits. In a test apparatus, the devices under test may be for example power semiconductor dies. When embodied as a test apparatus, the electronic apparatus may carry out a static test (for instance applying a static electric stimulus to the devices under test) and/or a dynamic test (for instance applying pulses to the devices under test). For example, the electronic apparatus may be configured as a test apparatus testing the devices under test sequentially and/or simultaneously. For example, 2-32 (or more) devices under test may be tested simultaneously.

However, an electronic apparatus according to an exemplary embodiment may also be applied to other electronic applications: For instance, exemplary embodiments may be implemented for a parallel measurement of high-voltage semiconductors. Another exemplary application of exemplary embodiments is the provision of a high-voltage protection circuitry in any electronic circuitry in which high voltage can occur in the electronic system or measuring system. For example, said electronic devices and/or further electronic devices may comprise input stages, analog-to-digital converters (ADC), input/output stages (I/O), operational amplifiers (or other amplifiers), and/or logic components.

Exemplary embodiments have advantages: In particular, the constituents of the electronic apparatus and in particular the electronic devices may be subject to a power limitation during operation, which may protect them and the electronic apparatus as a whole against damage. Furthermore, a greatly reduced resistor noise may be achieved. Moreover, exemplary embodiments may be embodied with a bidirectional design. In embodiments, it may be possible to protect sensitive semiconductor devices during operation of the electronic apparatus, for instance during testing the semiconductor devices.

According to an exemplary embodiment, a high-voltage source may be provided which supplies a high voltage to a plurality of electronic devices (such as electronic chips) connected in parallel electric paths. When a current in a respective electric path becomes excessive, the current may be limited in a high voltage-robust way. This may be done by current limiting circuits each connected in a respective one of said parallel paths. Advantageously, even in the event of a damaged electronic device, the remaining electronic apparatus remains uninfluenced. Furthermore, providing a respective current limiting circuit in each of parallel electric paths may protect one or more high-voltage sources and/or one or more low voltage sources. For example, a current limiting circuit may be embodied with at least one junction field-effect transistor (JFET), wherein cascading plural of such current limiting stages of a respective current limiting circuit (for instance cascading two or more junction field-effect transistors) may allow to operate the electronic apparatus with even higher voltage. For example, cascading may allow to operate the electronic apparatus at a voltage of up to 3000 V or more. Each of the cascaded or serialized current limiting stages of a respective current limiting circuit may limit current corresponding to a portion of an overall voltage (for instance may limit up to 1500 V when the overall voltage is 3000 V and two serial JFETs are provided).

FIG. 1 shows a schematic view of an electronic apparatus 100 according to an exemplary embodiment. FIG. 2 shows the electronic apparatus 100 according to FIG. 1 during operation, more specifically during failure of an electronic device 102A.

The electronic apparatus 100 according to FIGS. 1 and 2 comprises a plurality of parallel electric paths 104. Although three parallel electric paths 104 are shown in FIG. 1, any other larger or smaller number of parallel electric paths 104 is possible.

Furthermore, a plurality of electronic devices 102 form part of the electronic apparatus 100. Although three electronic devices 102 are shown in FIG. 1, any other larger or smaller number of electronic devices 102 is possible. According to FIGS. 1 and 2, one electronic device 102 is provided per electric path 104. Thus, each of the electronic devices 102 is arranged and is electrically connected in a respective one of said plurality of parallel electric paths 104. It may also be possible that plural electronic devices 102 are arranged in the same electric path 104 and connected serially and/or in parallel with each other (not shown). In the embodiment of FIGS. 1 and 2, the electronic apparatus 100 is configured as a test apparatus for electrically testing the electronic devices 102 as devices under test (DUT). For example, said devices under test may be transistor chips (for example field-effect transistors such as MOSFETs or bipolar transistors such as IGBTs), in particular semiconductor power chips. However and more generally, the electronic devices 102 may be for example any kind of semiconductor packages, semiconductor chips (for instance gallium nitride chips), semiconductor power devices, transistor components, diodes, etc. The electronic devices 102, in particular when embodied as DUTs, may be inserted temporarily or substitutably in the respective electric path 104 for testing, and may be removed out of the assigned electric path 104 after testing. The electronic devices 102 may be tested partially or entirely in parallel, or alternatively sequentially. The electronic test may be carried out by applying a static (and/or dynamic) electric stimulus signal, such as an electric stimulus voltage, and may encompass measuring an electric response signal, such as a leakage current measured by a current measuring mechanism 122 in each of the electric paths 104. For example, a leakage current may involve the measurement of current values in a range from 1 nA to 1000 nA. Other current values or ranges are possible. A respective current measuring mechanism 122 may be embodied for instance as an amperemeter. For example, the task of an electronic apparatus 100 according to an exemplary embodiment may be the measurement of leakage currents of the electronic devices 102 between a lower potential (for instance at 0 V) and an upper potential (for instance at 3 kV). When operating the electronic devices 102 at a voltage or potential difference between an upper electric potential provided by a common upper electric potential provision unit 118 and a lower electric potential provided by a path-individual lower electric potential provision unit 120, a resulting leakage current of the electronic devices 102 may be measured.

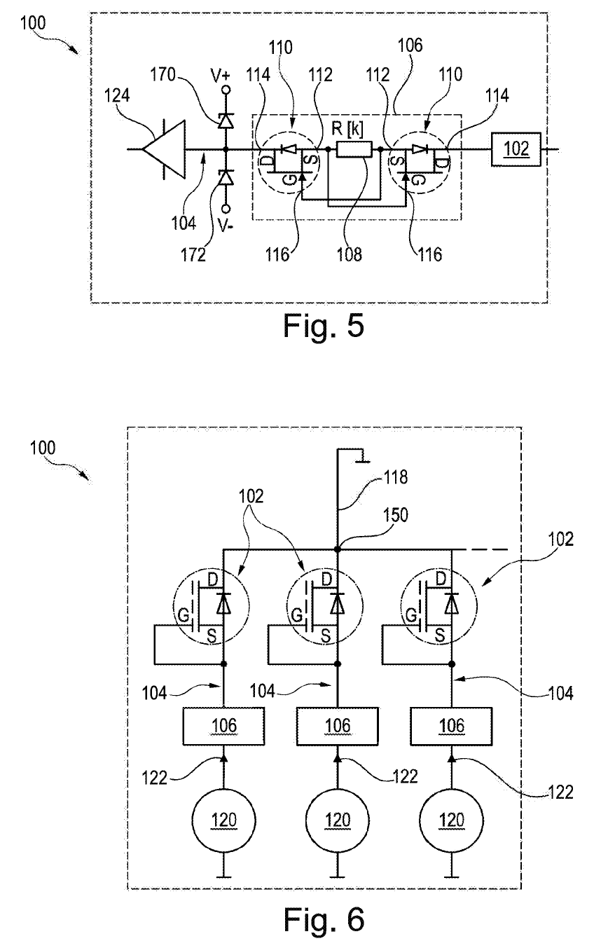

Moreover, the electronic apparatus 100 comprises a plurality of current limiting circuits 106. An embodiment of any of the current limiting circuits 106 will be described below in further detail referring to FIG. 3, wherein alternatively the current limiting circuits 106 of FIGS. 1 and 2 can also be embodied as shown in FIGS. 4 or 5, or in still another way. A respective one of said current limiting circuits 106 is arranged in an assigned one of said plurality of electric paths 104 and in series with an assigned one of said plurality of electronic devices 102. In other words, each electric path 106 may comprise a serial connection of an electronic device 102 and a current limiting circuit 106. Is also possible that a plurality of current limiting circuits 106 is arranged in one of said plurality of electric paths 104, for instance connected in series and/or parallel to each other. Each of the current limiting circuits 106 may be configured for limiting the electric current flowing in the assigned electric path 104. If the electric current flowing in the assigned electric path 104 becomes excessive (for instance exceeds a certain threshold value, which may be a predefined threshold value), the corresponding current limiting circuit 106 may limit the electric current flowing in the respective electric path 104 or may reduce the value of the electric current flowing in the respective electric path 104. In this way, each current limiting circuit 106 may prevent an excessive current flow in the assigned electric path 104 and through the assigned electronic device 102.

Advantageously, an impact of an assigned current limiting circuit 106 may be activated only when a certain electronic device 102 is defective, which may lead to an excessive current in the respective electric path 104. In the absence of a defect of the electronic devices 102, the current limiting circuits 106 may be entirely passive, as if they were absent.

As further shown in FIGS. 1 and 2, the electronic apparatus 100 comprises one common upper electric potential provision unit 118 connected to each of said parallel electric paths 104 via an electric connection node 150. The common upper electric potential provision unit 118 may be configured for providing and for maintaining a predefined upper electric potential, in particular a high voltage potential, to each of said parallel electric paths 104. For example, said high voltage potential may be at least 1000 V, for instance at least 3000 V or more.

Moreover, the electronic apparatus 100 comprises a plurality of lower electric potential provision units 120 each connected in a respective one of said parallel electric paths 104. Between each respective lower electric potential provision unit 120 and the common upper electric potential provision unit 118, an electric voltage (in particular a high voltage) may be defined which may be applied to the assigned electronic device 102 and the serially connected current limiter circuit 106. With the configuration according to FIGS. 1 and 2, each electric path 104 comprises a serial connection of a lower electric potential provision unit 120, a current limiting circuit 106 and an electronic device 102, while the common upper electric potential provision unit 118 may be shared between all parallel electric paths 104. For example, each electric path 104 may have an identical circuitry or at least a corresponding circuitry as the other electric paths 104. Each of the path-specific lower electric potential provision units 120 may be configured for providing and for maintaining a predefined lower electric potential in the assigned electric path 104. For instance, each lower electric potential provision unit 120 may provide a ground potential.

While the common upper electric potential provision unit 118 may force the electronic apparatus 100 to operate at a well-defined upper electric potential on one side of the serially connected electronic devices 102 and current limiter circuits 106, each lower electric potential provision unit 120 may force the electronic apparatus 100 to operate at a well-defined lower electric potential on the opposing other side of the serially connected electronic devices 102 and current limiter circuits 106. Consequently, lines 152 may be on high-voltage during operation of the electronic apparatus 100.

As further shown in FIGS. 1 and 2, each electric path 104 has a current measuring mechanism 122 for measuring a current at the assigned electronic device 102 when the upper electric potential provision unit 118 provides and maintains its predefined upper electric potential and when the assigned one of the lower electric potential provision units 120 provides and maintains its predefined lower electric potential. More specifically, each of the current measuring mechanisms 122 in a respective electric path 104 may carry out a leakage current measurement for measuring, at the applied voltage, a leakage current of a respective electronic device 102 being a device under test (DUT).

In the shown embodiment, each of the electronic devices 102 may be embodied as a field-effect transistor chip or package, for instance a metal oxide semiconductor field-effect transistor (MOSFET) chip for power semiconductor applications. In such an embodiment, the common upper electric potential provision unit 118 may be connected to drain terminals 154 (“D” in FIG. 1) of each of the electronic devices 102. A side of each respective current limiting circuit 106 opposing the respective lower electric potential provision unit 120 may be connected with a source terminal 156 (“S” in FIG. 1) and a gate terminals 158 (“G” in FIG. 1) of the assigned electronic device 102.

To put it shortly, each current limiting circuit 106 may be configured for limiting a current flow when or as long as an electric current flowing through the respective current limiting circuit 106 exceeds a current limit value. By taking this measure, it may be prevented at any time that the electronic devices 102 are subjected to overcurrent. During normal operation, a high-voltage may be applied to the electronic devices 102 as devices under test, whereas no high-voltage may be present at an electronic device 102 in a protection scenario. This may protect the electronic devices 102 against damage and may also protect the electric potential provision units 118, 120 against failure or damage.

Now referring specifically to FIG. 2, a scenario is shown in which one of the electronic devices 102, namely electronic device 102A, is defective. In such an event, the current in the assigned electric path 104A may increase. This current flows through the high voltage current limiting module or current limiting circuit 106A and may cause a voltage drop (for instance across an adjustable resistance 108 such as a potentiometer, compare FIG. 3). This may trigger the current limiting circuit 106A to limit the current flowing through the electric path 104A (for example and referring again to FIG. 3, when the current limiting circuit 106A comprises a field-effect transistor such as a JFET, the gate of such a field-effect transistor may become more negative than its source and the field-effect transistor may begin to pinch off itself, which may lead to a high voltage current limitation).

As already mentioned, the electronic apparatus 100 according to FIG. 1 may be configured as a test arrangement for testing said electronic devices 102 preferably in parallel. In this context, the test arrangement may be configured for measuring one or more electrical properties, for instance an electric leakage current, of an assigned one of said plurality of electronic devices 102 in each of said electric paths 104. During parallel testing of electronic devices 102, it may be possible to electrically operate each of said plurality of electric paths 104 simultaneously for carrying out an electric test of said electronic devices 102 while protecting said electronic devices 102 against overcurrent by said plurality of current limiting circuits 106. At the same time, the electric potential provision units 118, 120 may be protected against failure or damage, for instance may avoid short-circuiting.

The electronic apparatus 100 configured as test system may serve for testing devices under test in form of the electronic devices 102, which may form part of a semiconductor wafer composed of a plurality of integrally connected transistor chips. Alternatively, the individual electronic devices 102 may be already separated from a wafer compound. In particular, the test system may be configured for testing the electronic devices 102 using constant voltage or non-constant or rapidly changing signals. During testing, it may be possible to supply one or more electric stimulus signals to the electronic devices 102 and to analyze electric response signals from the electronic devices 102 according to the test specification.

FIG. 3 shows a schematic view of a current limiting circuit 106 of an electronic apparatus 100 according to an exemplary embodiment.

The illustrated current limiting circuit 106 has a first terminal 160, which may be connected for example to a respective one of the electric potential provision units 120, and has a second terminal 162, which may be connected for instance to an electronic device 102 or the common first electric potential provision unit 118.

As shown, the illustrated current limiting circuit 106 comprises an optional variable or an adjustable resistance 108, such as a potentiometer, in series with a transistor 110, for example a field-effect transistor. For instance, the field-effect transistor may be a junction FET. Alternatively, the transistor 110 may be a bipolar transistor, such as an IGBT. In the shown embodiment, the transistor 110 is a field-effect transistor which has a source terminal 112 and a drain terminal 114, as well as a gate terminal 116. The gate terminal 116 is connected with the source terminal 112 (through the adjustable resistance 108). The gate terminal 116 and the adjustable resistance 108 are connected to the first terminal 160. The drain terminal 114 is connected to the second terminal 162. Preferably, the current limiting circuit 106 comprises a depletion-type transistor 110. The transistor 110 may be configured to be “on” (or electrically conductive) in the absence of a gate voltage, and which can be turned “off” (or made electrically non-conductive) in the presence of a sufficiently large gate voltage.

Descriptively speaking, the current limiting circuit 106 limits the current in the respective electric path 104 when the flowing current and the applied voltage between the opposing terminals 160, 162 becomes too large. When the current becomes excessively high and/or the high-voltage exceeds allowable values, current flow between source terminal 112 and drain terminal 114 is limited along the source-drain path, due to a significantly increased resistance caused by the voltage or current control of the gate terminal 116.

Advantageously, the operation of the current limiting circuit 106 of FIG. 3 is very fast, since switching of the field-effect transistor 110 is very fast. Hence, the current limiting circuit 106 has a very short response time. At the same time, the current limiting circuit 106 of FIG. 3 has a very simple construction, and is failure robust (in particular is not prone to be disturbed by oscillating).

FIG. 4 shows a schematic view of a current limiting circuit 106 of an electronic apparatus 100 according to another exemplary embodiment.

The current limiting circuit 106 of FIG. 4 differs from the current limiting circuit 106 of FIG. 3 in that, according to FIG. 4, the current limiting circuit 106 comprises two current limiting stages 106’, 106’’ each with the construction of the current limiting circuit 106 according to FIG. 3 and connected in series. More generally, construction of the current limiting stages 106’, 106’’ may be corresponding (in particular identical), or may be different (not shown).

As already mentioned, each of the current limiting stages 106’, 106’’ may comprise a transistor 110 which may be embodied for example as a JFET. Such a JFET may be used for example in voltage classes up to 1800 V. When two (or more) JFETs are connected in series or are cascaded as shown in FIG. 4, a maximum voltage applied to the electronic devices 102 can be increased, for instance can be increased up to 3000 V and more. If two current limiting stages 106’, 106’’ are connected in series as shown in FIG. 4, one of two JFETs may work as described above. The second JFET may be configured to go into a voltage breakdown when a maximum permissible current is reached. This means that one JFET takes over the voltage until breakdown voltage and the second JFET takes over the remaining voltage and the actual current limitation. Thus, the two serial current limiting stages 106’, 106’’ of FIG. 4 may allow to provide a particularly reliable current limiting functionality even at very high voltages.

FIG. 5 shows a schematic view of part of an electronic apparatus 100 according to another exemplary embodiment. FIG. 5 only shows one electric path 104 of the electronic apparatus 100, wherein other ones (not shown in FIG. 5) may be constructed similar or identical to the electric path 104 of FIG. 5, or differently from FIG. 5. The connection of the multiple electric paths 104 of the electronic apparatus 100 according to FIG. 5 may be accomplished for example as shown in FIG. 1, or in another way.

For example, the electronic devices 102 (one is shown in FIG. 5) of the electronic apparatus 100 according to FIG. 5 may be for example logic devices, operational amplifiers, input stages, analog-to-digital converters and/or devices under test. However, testing the electronic devices 102 is not the only application of electronic apparatuses 100 according to exemplary embodiments, so that an electronic apparatus 100 (as the one shown in FIG. 5) may be arranged also without a test system.

In the electric path 104 illustrated in FIG. 5, a serial connection of an electronic device 102, a current limiting circuit 106, and a further electronic device 124 is shown. Any of the electronic device 102 and the further electronic device 124 may be embodied for example as a driver circuitry, an analog-to-digital converter, an input stage, an operational amplifier, a logic circuitry, or another electronic member or system. As an alternative to FIG. 5, electronic device 102 or further electronic device 124 may also be omitted. According to FIG. 5, electronic device 102 and/or further electronic device 124 may be protected against overcurrent and high voltage by the current limiting circuit 106 in the same electric path 104 as electronic device 102 and/or further electronic device 124. In FIG. 5, further electronic device 124 may for instance be embodied as an operational amplifier. Electronic device 102 may for example (but not necessarily) be embodied as a device under test (DUT) in the framework of a test system.

Still referring to FIG. 5, the illustrated current limiting circuit 106 may comprise an adjustable resistance 108 (indicated as R[k] in FIG. 5) arranged between two transistors 110 of the current limiting circuit 106. For example, each of the two transistors 110 may be constructed as described above referring to FIG. 3. In the shown embodiment, the source terminals 112, 112 of the transistors 110, 110 face each other and are separated by the adjustable resistor 108, whereas the drain terminals 114, 114 face away from each other and from the adjustable resistor 108. One connection terminal of the adjustable resistor 108 is connected to the source terminal 112 of a first one of the transistors 110 and with the gate terminal 116 of the other transistor 110, whereas the other connection terminal of the adjustable resistor 108 is connected to the source terminal 112 of the other of the transistors 110 and with the gate terminal 116 of the first mentioned transistor 110 (see FIG. 5).

Optionally, one or more further electronic members may be connected in electronic apparatus 100, such as diodes 170, 172 shown in FIG. 5 and operating between respective voltages V+, V-.

Hence, FIG. 5 shows an embodiment with a high voltage current limit module and a high voltage protection circuit in form of the current limiting circuit 106. Protective circuitry in series with one or more components to be protected in form of electronic device(s) 102/124 is provided. A small resistance in relation to current can be achieved (for example less than 1 kΩ at 10 mA). Moreover, the electronic apparatus 100 according to FIG. 5 may experience a very low resistive noise. The entire construction of electronic apparatus 100 which may use simple components ensuring a low manufacturing effort.

FIG. 6 shows a schematic view of an electronic apparatus 100 according to another exemplary embodiment.

The embodiment of FIG. 6 differs from the embodiment of FIG. 1 in particular in that, according to FIG. 6, the role of the common first electric potential provision unit 118 and the plurality of second electric potential provision units 120 are exchanged. In FIG. 1, the common first electric potential provision unit 118 provides a higher electric potential (for instance a high voltage of at least 1 kV) than the plurality of second electric potential provision units 120 providing a lower electric potential (for instance mass potential) in a respectively assigned electric path 104. In contrast to this, in FIG. 6, the common first electric potential provision unit 118 provides a lower electric potential (for instance mass potential) than the plurality of second electric potential provision units 120 providing a higher electric potential (for instance a high voltage of at least 1 kV). Thus, there is also the option of a common lower electric potential provided by the common first electric potential provision unit 118 at a lower level than the higher electrical potential on each other end of the electric paths 104 provided by the plurality of second electric potential provision units 120.

It should be noted that the term “comprising” does not exclude other elements or features and the “a” or “an” does not exclude a plurality. Also elements described in association with different embodiments may be combined. It should also be noted that reference signs shall not be construed as limiting the scope of the claims. Moreover, the scope of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. An electronic apparatus, comprising:
a plurality of parallel electric paths;
a plurality of electronic devices each arranged in a respective one of said plurality of parallel electric paths; and
a plurality of current limiting circuits each arranged in an assigned one of said plurality of electric paths and in series with an assigned one of said plurality of electronic devices.

2. The electronic apparatus according to claim 1, wherein at least one of said current limiting circuits comprises of an adjustable resistance in series with a transistor or arranged between two transistors.

3. The electronic apparatus according to claim 1, wherein at least one of said current limiting circuits comprises a transistor having two connection terminals, in particular a source terminal and a drain terminal, and a control terminal, in particular a gate terminal, connected with one of said connection terminals.

4. The electronic apparatus according to claim 1, wherein at least one of said current limiting circuits comprises a field-effect transistor having a source terminal, a drain terminal and a gate terminal connected with the source terminal.

5. The electronic apparatus according to claim 1, wherein at least one of said current limiting circuits comprises a depletion-type transistor.

6. The electronic apparatus according to claim 1, wherein at least one of said current limiting circuits comprises at least two current limiting stages, in particular at least two current limiting stages with corresponding circuitry, connected in series.

7. The electronic apparatus according to claim 1, comprising a common first electric potential provision unit connected to each of said parallel electric paths and configured for maintaining a predefined first electric potential, in particular a high voltage potential, provided to each of said parallel electric paths.

8. The electronic apparatus according to claim 1, comprising a plurality of second electric potential provision units each connected in a respective one of said parallel electric paths and configured for maintaining a predefined second electric potential in the assigned electric path, in particular a ground potential.

9. The electronic apparatus according to claim 7, wherein each electric path has a current measuring mechanism for measuring a current at the assigned electronic device when the first electric potential provision unit maintains its predefined first electric potential and when the assigned one of the second electric potential provision units maintains its predefined second electric potential.

10. The electronic apparatus according to claim 7, wherein an electric voltage between the first electric potential and the second electric potential is at least 300 V, in particular at least 1 kV.

11. The electronic apparatus according to claim 7, wherein the common first electric potential provision unit is connected to drain terminals of each of the electronic devices.

12. The electronic apparatus according to claim 1, wherein each current limiting circuit is configured for limiting a current flow when or as long as an electric current flowing through the respective current limiting circuit exceeds a current limit value.

13. The electronic apparatus according to claim 1, wherein each electric path comprises an identical circuitry.

14. The electronic apparatus according to claim 1, wherein the electronic devices are semiconductor packages, semiconductor chips, semiconductor power devices, transistor components, diodes, logic devices, operational amplifiers, input stages, analog-to-digital converters or devices under test.

15. The electronic apparatus according to claim 1, configured as a test arrangement for testing said electronic devices, in particular simultaneously.

16. The electronic apparatus according to claim 15, wherein the test arrangement is configured for measuring at least one electrical property, in particular an electric current, more particularly an electric leakage current, of an assigned one of said plurality of electronic devices in each of said electric paths.

17. The electronic apparatus according to claim 1, comprising at least one of a driver circuitry, an analog-to-digital converter, an input stage, an operational amplifier, or a logic circuitry encompassing at least one of said electronic devices or forming at least one further electronic device in at least one of said electric paths.

18. A method, comprising:
arranging each of a plurality of electronic devices in a respective one of a plurality of parallel electric paths;
arranging each of a plurality of current limiting circuits in an assigned one of said plurality of electric paths and in series with an assigned one of said plurality of electronic devices; and
electrically operating each of said plurality of electric paths.

19. The method according to claim 18, wherein the method comprises electrically operating each of said plurality of electric paths, in particular simultaneously, for carrying out an electric test of said electronic devices while protecting said electronic devices against overcurrent by said plurality of current limiting circuits.

20. The method according to claim 18, wherein the method comprises electrically operating each of said plurality of electric paths for providing a functionality of at least one of a driver circuitry, an analog-to-digital converter, an input stage, an operational amplifier, or a logic circuitry formed by at least one further electronic device or encompassed by said electronic devices, the at least one further electronic device or said electronic devices being protected against overcurrent and high voltage by said plurality of current limiting circuits.
